(19) United States
(12) Patent Application Publication
(10) Pub. No.: US 2026/0162562 A1
(43) Pub. Date: Jun. 11, 2026

(54) MECHANICAL APPARATUS FOR ILLUSTRATING THE RELATIONSHIP BETWEEN ANGLES AND TRIGONOMETRIC FUNCTIONS

(71) Applicant: Brady Richter, Long Island City, NY (US)

(72) Inventor: Brady Richter, Long Island City, NY (US)

(21) Appl. No.: 18/880,737

(22) PCT Filed: Oct. 4, 2024
(86) PCT No.: PCT/US2024/049918

§ 371 Date: Jan. 2, 2025

Related U.S. Application Data
(60) Provisional application No. 63/543,348, filed on Oct. 10, 2023.

(51) Int. Cl. G09B 23/04

(52) U.S. Cl. CPC G09B 23/04

(57) ABSTRACT

A mechanical apparatus designed to easily and clearly show the user the relationship between angles and trigonometric functions without the use of a computer or calculator. The mechanical nature of the apparatus is an effective educational tool for those learning how to calculate trigonometric values, the relationship between trigonometric functions, and the relationship between angles and trigonometric functions.

### BACKGROUND

Trigonometric functions (also called circular functions, angle functions, or goniometric functions) relate an angle of a right-angled triangle to ratios of two side lengths. They are widely used in all sciences that are related to geometry, such as navigation, solid mechanics, celestial mechanics, geodesy, and many others. They are among the simplest periodic functions, and as such are also widely used for studying periodic phenomena through Fourier analysis.

The trigonometric functions most widely used in modern mathematics are sine. cosine, and tangent. Their reciprocals are respectively cosecant, secant, and cotangent, which are less used. Each of these six trigonometric functions has a corresponding inverse function. and an analog similarly bebaving hyperbolic function defined by different geometric shapes. such as a hyperbola.

The oldest definitions of trigonometric functions, related to right-angle triangles, define them only for acute angles. To extend the sine and cosine functions to functions whose domain is the whole real line, geometrical definitions using the standard unit circle (i.e., a circle with a radius of 1 unit) are often used; then the domain of the other functions is the real line with some isolated points removed. Modern definitions express trigonometric functions as infinite series or as solutions of differential equations. This allows extending the domain of sine and cosine functions to the whole complex plane, and the domain of the other trigonometric functions to the complex plane with some isolated points removed.

Determining the trigonometric values can be complicated for those less comfortable and skilled with math. The introduction of calculators and computers has eliminated the need for many to understand these trigonometric functions.

What would be useful is a mechanical apparatus to provide a simple visual educational aid for assisting and supporting those learning trigonometry.

### SUMMARY

According to one embodiment, a mechanical trigonometric visualization apparatus includes a first panel, a dial, a rotating arm, a first slotted link mechanism, a second slotted link mechanism, and a second panel. The first panel is configured with a hole and a plurality of slots formed therein. A first side of the first panel includes a surface having values for a trigonometric function identified along each of the slots and angle values identified for an angle circle oriented around the hole. The dial has a first end that acts as an indicator and a first axle extending from a second end. The dial is located on the first side of the first panel and the first axle passes through the hole. The dial is configured to rotate in order for the indicator to select an angle from the angle circle. The rotating arm is located on a second side of the first panel and is secured to the first axle. The rotating arm rotates in conjunction with rotation of the dial and includes a second axle at a distal end thereof.

The first slotted link mechanism is coupled to the second axle. The first slotted link mechanism is configured to move back and forth in a first linear direction based on rotational movement of the rotating arm. The first slotted link mechanism includes at least one first protrusion in alignment with at least one slot and the at least one first protrusion acts as at least one first marker for at least one first associated trigonometric function and a location of the at least one first marker identifies a value for the at the least one first associated trigonometric function for the angle selected by the indicator. The second slotted link mechanism is coupled to the second axle. The second slotted link mechanism is configured to move back and forth in a second linear direction based on rotational movement of the rotating arm. The second slotted link mechanism includes at least one second protrusion in alignment with at least one slot and the at least one second protrusion acts as at least one second marker for at least one second associated trigonometric function and a location of the at least one second marker identifies a value for the at least one second associated trigonometric function for the angle selected by the indicator. The second panel is configured to connect to the first panel to enclose the rotating arm, the first slotted link mechanism, and the second slotted link mechanism therebetween.

According to one embodiment, a mechanical trigonometric visualization apparatus includes a panel, a dial, and a mechanical mechanism. The panel has a plurality of linear slots, wherein each linear slot has values associated with at least one trigonometric function identified with location along the linear slot. The panel also includes an angle circle with angle values indicated around the angle. The dial is connected to the panel in order to select an angle from the angle circle. The mechanical mechanism connected to the dial translates the rotational movement of the dial to linear movement. The mechanical mechanism is configured to provide an indication along the plurality of linear slots that will indicate an associated trigonometric function with the selected angle.

### BRIEF DESCRIPTION OF DRAWINGS

The features and advantages of the various embodiments will become apparent from the following detailed description in which:

FIG. 1 illustrates a front view of an example mechanical apparatus to clearly show the user the relationship between angles and trigonometric functions (a mechanical trigonometric visualization apparatus), according to one embodiment;

FIGS. 2A-B illustrate front views of example first panels of a mechanical trigonometric visualization apparatus, according to various embodiments;

FIGS. 3A-D illustrate various exploded perspective views of an example mechanical trigonometric visualization apparatus, according to one embodiment;

FIG. 4A-C illustrate a series of images of an underside of the first panel showing various components being secured together, according to one embodiment;

FIG. 5 illustrates a close-up of the underside of the first panel, according to one embodiment;

FIG. 6 illustrates a simplified cross-sectional side view of the apparatus, according to one embodiment;

FIG. 7 illustrates a perspective view of the apparatus in a closed configuration, according to one embodiment.

### DETAILED DESCRIPTION

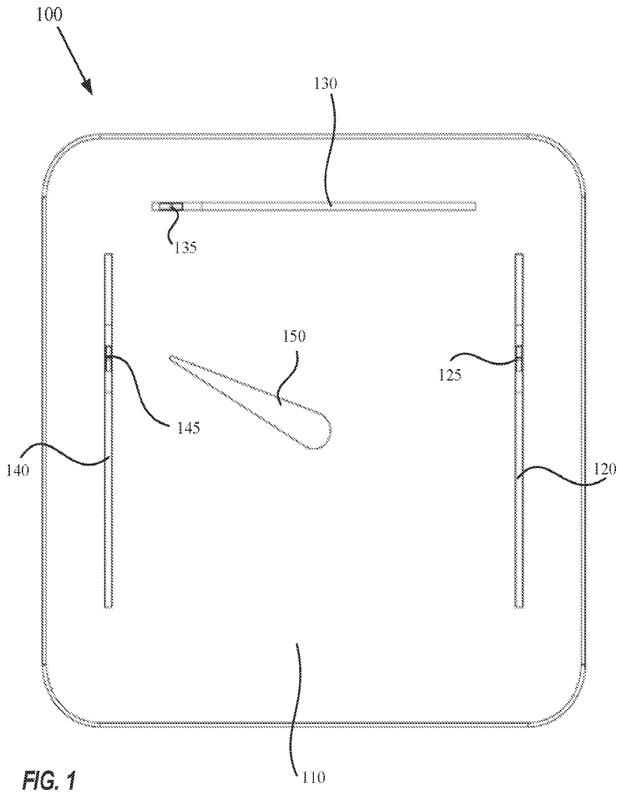

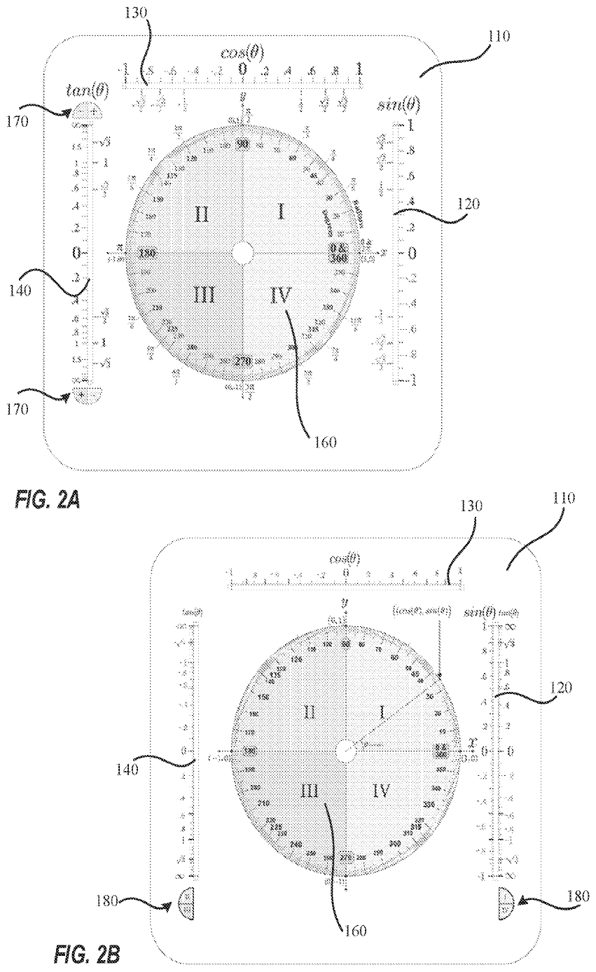

FIG. 1 illustrates a front view of an example mechanical trigonometric visualization apparatus 100. The apparatus is designed to clearly show the user the relationship between angles and trigonometric functions. The apparatus 100 includes a first (front) panel 110 that includes markings that will be used to define the relationships (markings are not shown for ease of illustration). The first panel 110 includes three slots 120, 130, 140 that along with markers 125, 135, 145 are used to identify values for the various trigonometric functions. The first panel 110 also includes a dial 150 that is used to select an angle. As the dial 150 is rotated to different angles, the markers 125, 135, 145 are moved within the slots 120, 130, 140 and the location within the slots 120, 130, 140 defines the value for the trigonometric functions associated with the angle.

FIG. 2A illustrates an example graphic illustration for a first (outer) surface of the first panel 110 of the example mechanical trigonometric visualization apparatus 100. The slot 120 is associated with the sine function, the slot 130 is associated with the cosine function, and the slot 140 is associated with the tangent function. The values for the sine, cosine, and tangent functions are identified along the associated slots 120, 130, 140. While the markers 125, 135, 145 are not illustrated for ease of illustration, the location of the markers within the slots 120, 130, 140 will identify the sine, cosine, and tangent values for the selected angle. The manner in which the markers move based on the angle selected will be described in more detail later. The middle of the outer surface of the first panel 110 has an angle circle 160 formed thereon so that the dial 150 (not illustrated for ease of illustration) can be used to select an angle. The angle circle 160 also identifies the four quadrants.

As the tangent values on each side (left and right) of the angle circle 160 are the additive inverses of corresponding angles on the other side (e.g., an 80° angle and a 100° angle are both 10° to either side of 90° and therefore have the same tangent value except the 100° angle is a negative value), the identification of the tangent value is not as straightforward as the other functions. As a single set of tangent values is identified, the quadrant of the angle selected is utilized to determine whether the tangent value identified is the value identified or the inverse thereof. As illustrated, a quadrant key (legend) 170 is provided above and below the slot 140 to identify whether to use the value or the inverse thereof. The quadrant key 170 indicates the value identified is the value (+) if the angle is in quadrant I or III and is the inverse (−) thereof if the angle is in quadrant II or IV.

According to an alternative embodiment, rather than utilize a quadrant key to determine whether to use the number or the inverse thereof, the values associated with tangent can be located on both sides of the slot 140 with the values on the left being the inverse of the values on the right. When the angle selected is on the right side (quadrant I, IV) of the angle circle 160, the markings on the right are read, and when the angle selected is on the left side (quadrant II, III) of the angle circle 160, the markings on the left are read. A quadrant key showing when to read from which side could be utilized.

FIG. 2B illustrates an example graphic illustration for the first (outer) surface of the first panel 110 of the example mechanical trigonometric visualization apparatus 100. In this example, rather than having to determine whether to use the tangent value identified by the marker on the slot 140 or the inverse thereof as in FIG. 2A, the tangent values are also identified in relation to the slot 120. That is, the slot 120 is associated with both sine values and tangent values. The tangent values associated with slot 120 are the inverse of the tangent values associated with slot 140. The tangent value is read from slot 120 if the angle selected is on the right side (quadrant I, IV) of the angle circle 160 and is read from slot 140 when the angle selected is on the left side (quadrant I, IV) of the angle circle 160. As illustrated, a quadrant key 180 is provided for slots 120, 140. The quadrant key 180 indicates the tangent value should be read from the slot 120 when the angle selected is on the right side (quadrant I, IV) of the angle circle 160 and from the slot 140 when the angle selected is on the left side (quadrant II, III) of the angle circle 160.

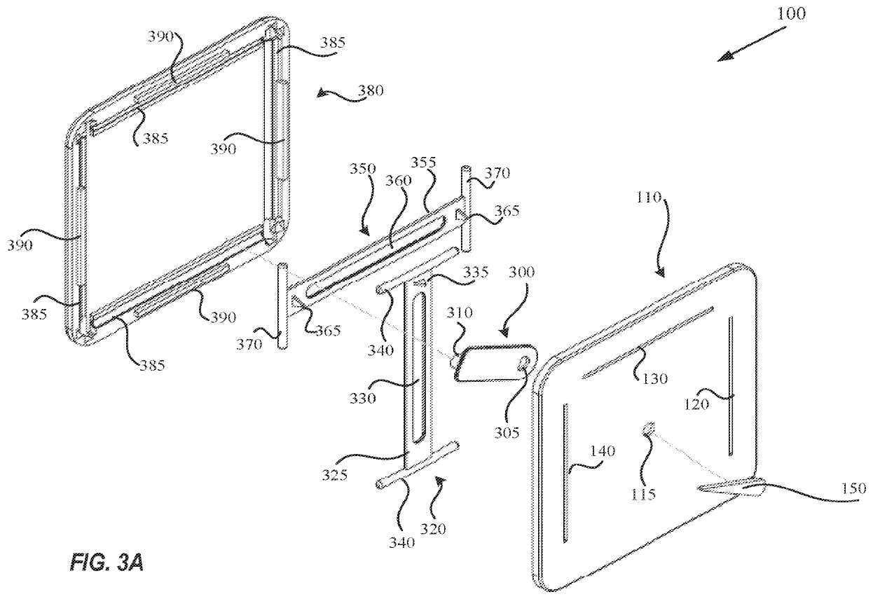

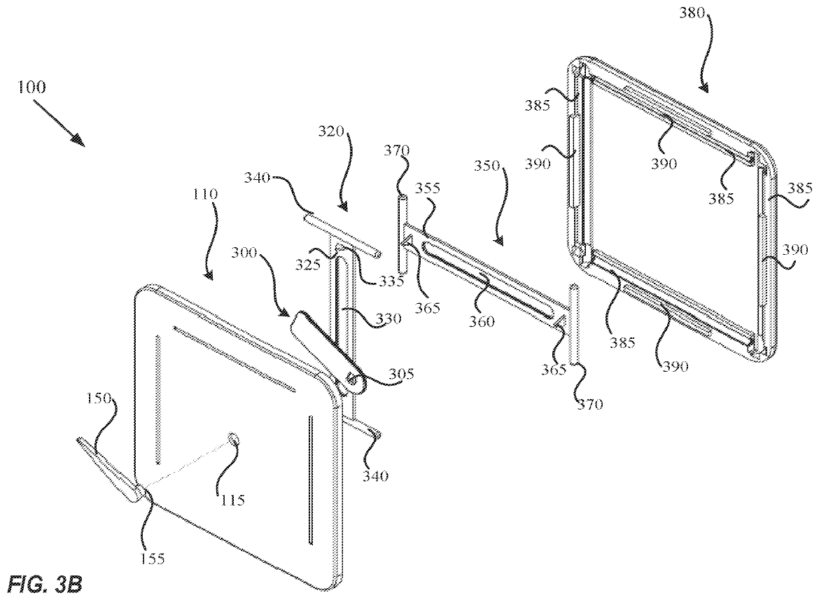

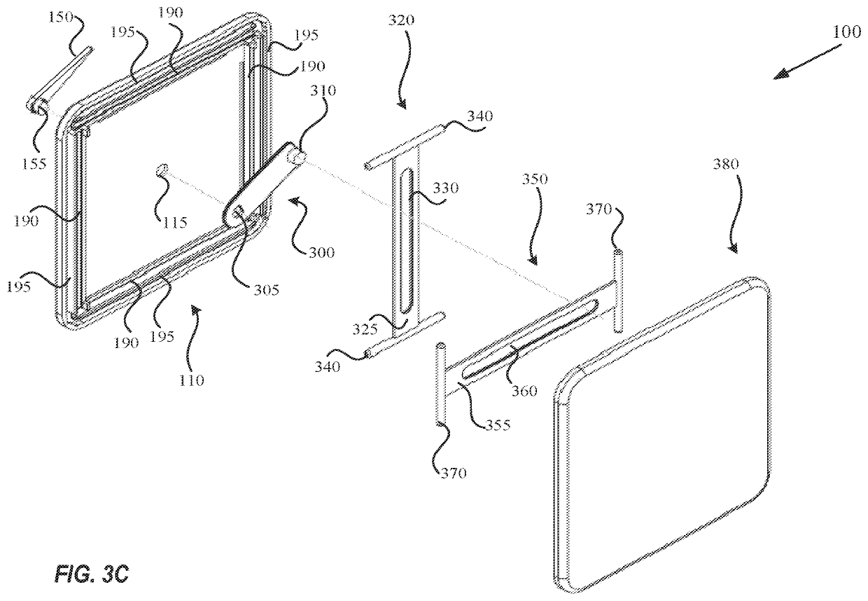

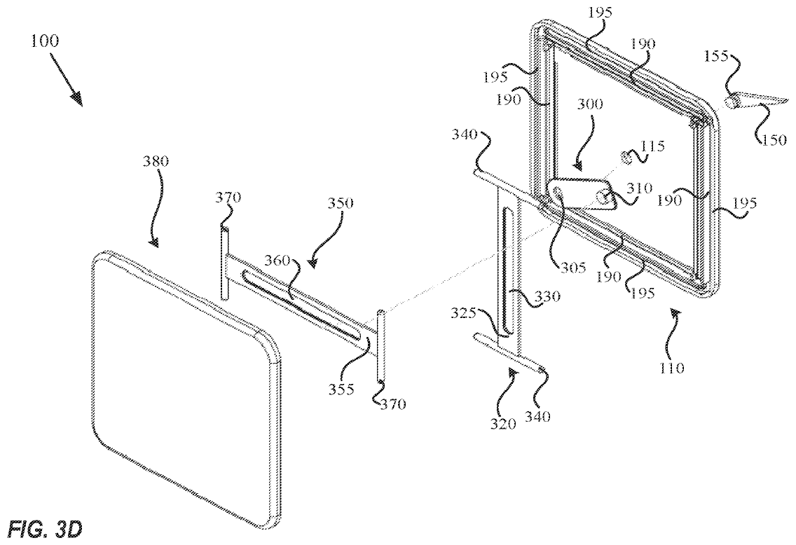

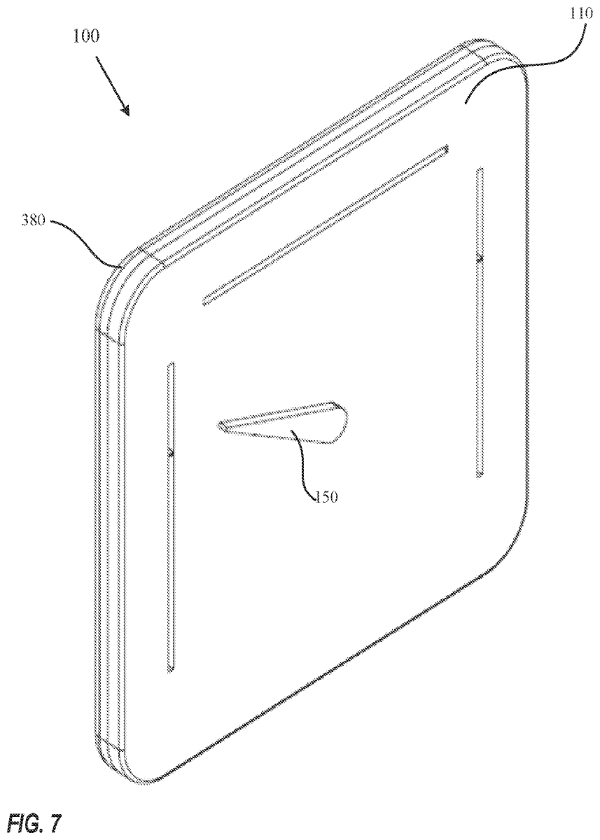

FIGS. 3A-3D illustrate different exploded perspective views of the example mechanical trigonometric visualization apparatus 100. The apparatus 100 includes the first panel 110, the dial 150 a rotating arm 300, a first slotted link mechanism (scotch yoke) 320, a second slotted link mechanism (scotch yoke) 350, and a second (back) panel 380. The rotating arm 300, the first slotted link mechanism 320, and the second slotted link mechanism 350 are located between the first panel 110 and the second panel 380 and are not visible (are located internally) when the apparatus 100 is put together (as illustrated in FIG. 7). The first panel 110 includes the slots 120, 130, 140 as well as a hole 115 in the center thereof for receiving an axle 155 of the dial 150. The rotating arm 300 includes a hole 305 therein (on a first side thereof as illustrated) for receiving the axle 155 and securing the rotating arm 300 and the dial 150 together on a back side of the first panel 110. The rotating arm 300 and the dial 150 are secured together in a defined arrangement (in the same direction as illustrated) and the rotating arm 300 rotates in sync (in the same direction) with the dial 150. A far (opposite) end of the rotating arm 300 includes an axle 310 extending away from the first panel 110.

The first slotted link mechanism 320 is configured to convert the rotational motion of the dial 150 into linear (horizontal in this embodiment) motion. The first slotted link mechanism 320 includes a body 325 (vertically oriented in this embodiment) having a channel 330 formed therein. On each side of the body 325 is a rod 340 extending perpendicular thereto in both directions. The rods 340 are utilized to move the first slotted link mechanism 320 within the apparatus 100 (left to right and vice versa in this embodiment). The first slotted link mechanism 320 also includes a protrusion (tab) 335 extending from a first (upper) side. The protrusion 335 is in alignment with the slot 130 in the first panel 110 and is designed to function as the marker 135 (for the cosine function in this embodiment).

The second slotted link mechanism 350 is configured to convert the rotational motion of the dial 150 into linear (vertical in this embodiment) motion. The second slotted link mechanism 350 includes a body 355 (horizontally oriented in this embodiment) having a channel 360 formed therein. On each side of the body 355 is a rod 370 extending perpendicular thereto in both directions. The rods 370 are utilized to move the second slotted link mechanism 350 within the apparatus 100 (top to bottom and vice versa in this embodiment). The second slotted link mechanism 350 also includes protrusions (tabs) 365 extending from each side. The protrusions 365 are in alignment with the slots 120, 140 respectively in the first panel 110 and are designed to function as the markers 125, 145 (for sine and tangent functions in this embodiment).

The first and the second slotted link mechanisms 320, 350 are each secured to the rotating arm 300 by placing the respective channels 330, 360 over the axle 310. When the dial 150 is rotated the rotating arm 300 is also rotated. The rotation of the rotating arm 300 causes movement of the first and the second slotted link mechanisms 320, 350. The first slotted link mechanism 320 moves horizontally (left to right and vice versa) and the second slotted link mechanism 350 moves vertically (top to bottom and vice versa).

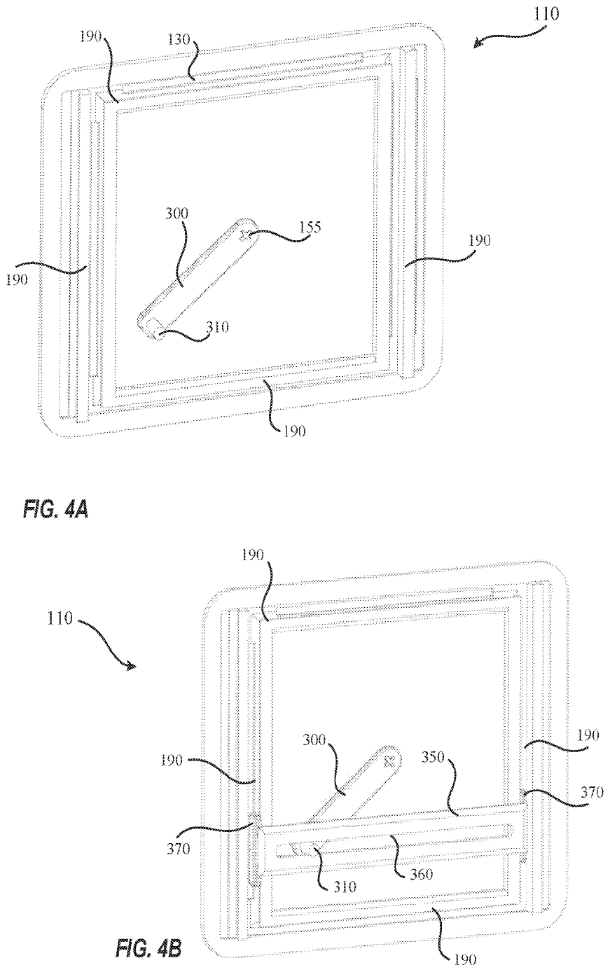

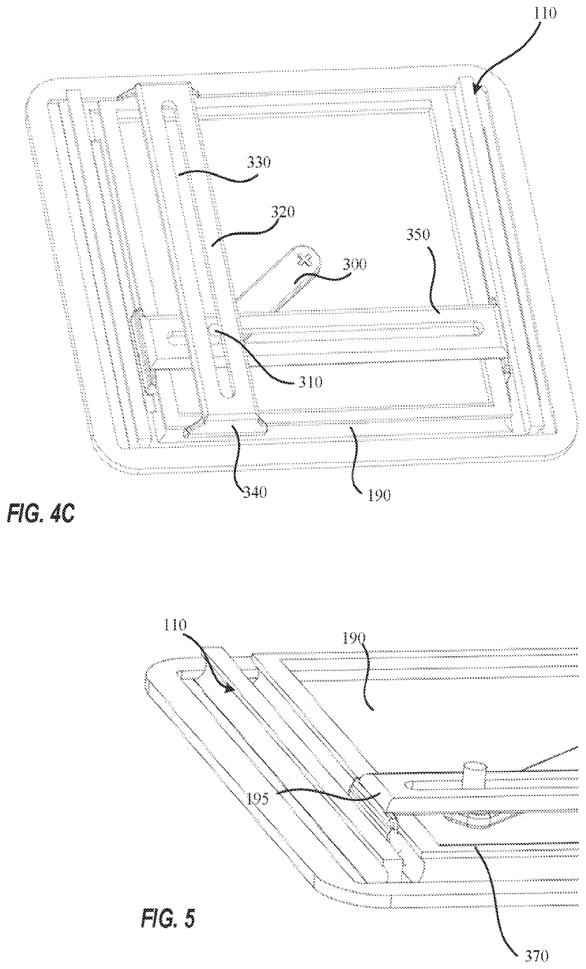

FIGS. 4A-C illustrate a series of images of an underside of the first panel 110 showing various components being secured together. FIG. 4A illustrates the rotating arm 300 secured to the axle 155. The rotating arm 300 includes the axle 310 at the distal end thereof. The first panel 110 includes channels 190 along each edge for receiving the rods 340, 370 of the first and second slotted link mechanisms 320, 350. FIG. 4B illustrates the second slotted link mechanism 350 being positioned in place such that the channel 360 receives the axle 310 and the rods 370 are located within the channels 190 (left and right in this embodiment). The second slotted link mechanism 350 may be moved linearly (up and down in this embodiment) based on the rotational movement of the dial 150 and rotating arm 300 FIG. 4C illustrates the first slotted link mechanism 320 being positioned in place such that the channel 330 receives the axle 310 and the rods 340 are located within the channels 190 (top and bottom in this embodiment). The first and the second slotted link mechanisms 320, 350 are perpendicular to each other (are 90 degrees out of phase). The first slotted link mechanism 320 may be moved linearly (left and right in this embodiment) based on the rotational movement of the dial 150 and rotating arm 300.

FIG. 5 illustrates a close-up of the underside of the first panel 110. The channel 190 and the rod 370 located therewithin are clearly visible.

Considering the components of FIGS. 3A-D and the front surface of the first panel 110 illustrated in FIG. 2A, a description of how the markers move based on movement of the dial 150 through the angle circle 160 is provided. Starting with the dial 150 at 0° (3:00), the protrusion 335 (acting as marker 135) on the first slotted link mechanism 320 is at the right side, and the protrusions 365 (acting as markers 125, 145) on the second slotted link mechanism 350 are centered vertically. As the dial 150 is moved counter-clockwise to 90° (12:00), the protrusion 335 (marker 135) moves to the left until it is centered horizontally and the protrusions 365 (markers 125, 145) move upward until they reach the top. As the dial 150 continues to move counter-clockwise to 180° (9:00), the marker 135 continues to move to the left until it reaches the left side, and the markers 125, 145 move downward until they are centered vertically. As the dial 150 continues to move counter-clockwise to 270° (6:00), the marker 135 moves to the right until it is centered horizontally, and the markers 125, 145 continue to move downward until they reach the bottom. As the dial 150 continues to move counter-clockwise back to 0° (the original position), the marker 135 continues to move to the right until it reaches the right side, and the markers 125, 145 move upward until they are centered vertically.

The second panel 380 and the first panel 110 have aligned channels 190, 385 that provide a pathway to enable the rods 340, 370 to move therewithin when the apparatus 100 is put together. The apparatus 100 also includes a connection means for securing the second panel 380 and the first panel 110 together. As illustrated, the connection means includes protrusions 390 extending from the second panel 380 in alignment with channels 195 formed in the back of the first panel 110. The second panel 380 and the first panel 110 are secured together by pushing the protrusions 390 into the channels 195. The second panel 380 and the first panel 110 can be separated by pulling on the second panel 380 until the protrusions 390 are removed from the channels 195. The connection means is in no way intended to be limited to the illustrated embodiment. As one skilled in the art would recognize, the connection means could include any combination of straps, tabs, pins, clamps, clips, or the like.

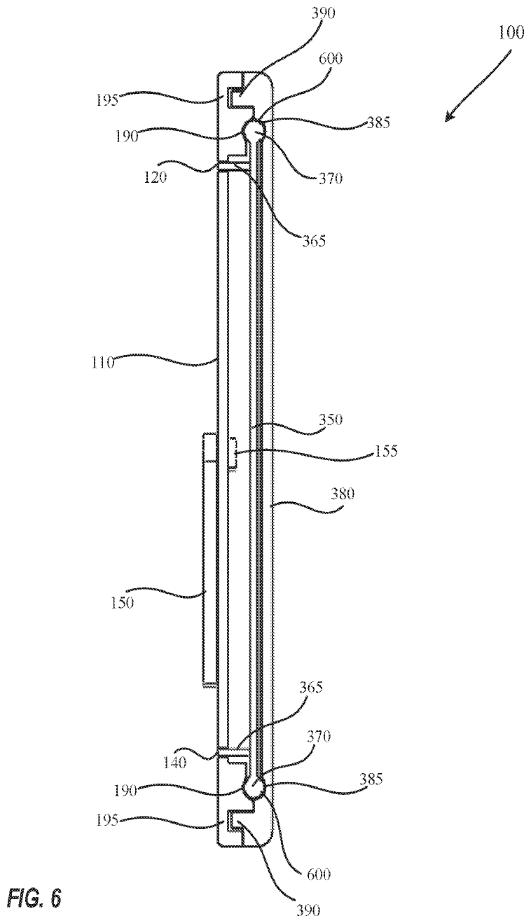

FIG. 6 illustrates a simplified cross-sectional side view of the apparatus 100. The simplified view does not show all of the components (the rotating arm 300 and the first slotted link mechanism 320) for ease of illustration. As illustrated, the aligned channels 190, 385 create a pathway 600 that the rods 370 of the second slotted link mechanism 350 can slide within. The protrusions 365 extend through the slots 120, 140 to function as markers 125, 145. The first slotted link mechanism 320 is located above the second slotted link mechanism 350, and the rotating arm 300 is located thereabove (but they are not illustrated for ease of illustration).

The connection means is provided by the protrusions 390 and the channels 195 located external to the pathway 600. The protrusions 390 are placed into the channels 195 to secure the second panel 380 and the first panel 110.

FIG. 7 illustrates a perspective view of the apparatus 100 in a closed configuration.

The apparatus 100 was disclosed as presenting the trigonometric functions on three sides thereof (left, right, top) via slots and markers. The sine function is presented on the right, the cosine function is presented on the top, and the tangent function is presented on the left (or left and right as shown in FIG. 2B). The apparatus is in no way intended to be limited thereto. For example, a slot and marker could be included on the bottom in place of one of the other slots and markers (e.g., top) or in addition to the other slots and markers without departing from the current scope. As the slotted link mechanisms 320, 350 are linked together in a defined arrangement with the rotating arm 300 and dial 150, the trigonometric functions may be displayed on different sides (as long as labeled correctly) without departing from the current scope. As the tangent values are centered around the 0-180° axis of the angle circle 160 and the values on each side of the 90-270° axis of the angle circle 160 are additive inverses of each other, tangent should logically be located on the left and/or right side. Likewise, as the sine values are centered around the 0-180° axis of the angle circle 160, sine should logically be located on the left or right side. As the cosine values are centered around the 90-270° axis of the angle circle 160, cosine should logically be located on the top or bottom. Accordingly, tangent could be on the right, sine on the left, and cosine on the bottom without departing from the current scope.

Furthermore, as disclosed the tangent function requires a legend to determine whether to use the value presented or apply an inverse thereto (or to take the value from one side or the other of the slot). The apparatus could be configured such that the tangent is identified on both sides of the device (like in FIG. 2B but the sine value could be moved to the left) and the value was read from one side or the other based on which side of the angle circle 160 the angle selected was.

According to one embodiment, other trigonometric functions could also be identified by adding additional markings to the slots. It should be noted that cotangent like tangent, has inverse values depending on which side (top or bottom) of the angle circle 160 the angle selected is. As such, this function would logically be identified on the top and/or bottom of the apparatus.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure, or characteristic described therein is included in at least one embodiment. Thus, the phrases “in one embodiment” or “in an embodiment” appearing in various places throughout the specification are not necessarily all referring to the same embodiment.

The various embodiments are intended to be protected broadly within the spirit and scope of the appended claims.

1. A mechanical trigonometric visualization apparatus comprising:
a first panel configured with a hole and a plurality of slots formed therein, wherein a first side includes a surface having values for a trigonometric function identified along each of the slots and angle values identified for an angle circle oriented around the hole;
a dial having a first end that acts as an indicator and a first axle extending from a second end, wherein the dial is located on the first side of the first panel and the first axle passes through the hole, and wherein the dial is configured to rotate in order for the indicator to select an angle from the angle circle;
a rotating arm located on a second side of the first panel and secured to the first axle, wherein the rotating arm rotates in conjunction with rotation of the dial, and wherein the rotating arm includes a second axle at a distal end thereof;
a first slotted link mechanism coupled to the second axle, wherein the first slotted link mechanism is configured to move back and forth in a first linear direction based on rotational movement of the rotating arm, wherein the first slotted link mechanism includes at least one first protrusion in alignment with at least one slot and the at least one first protrusion acts as at least one first marker for at least one first associated trigonometric function, and wherein a location of the at least one first marker identifies a value for the at the least one first associated trigonometric function for the angle selected by the indicator;
a second slotted link mechanism coupled to the second axle, wherein the second slotted link mechanism is configured to move back and forth in a second linear direction based on rotational movement of the rotating arm, wherein the second slotted link mechanism includes at least one second protrusion in alignment with at least one slot and the at least one second protrusion acts as at least one second marker for at least one second associated trigonometric function, and wherein a location of the at least one second marker identifies a value for the at least one second associated trigonometric function for the angle selected by the indicator; and
a second panel configured to connect to the first panel to enclose the rotating arm, the first slotted link mechanism, and the second slotted link mechanism therebetween.

2. The apparatus of claim 1, wherein both the first slotted link mechanism and the second slotted link mechanism move in response to rotation of the dial.

3. The apparatus of claim 1, wherein the first linear direction is horizontal and the second linear direction is vertical.

4. The apparatus of claim 1, wherein the plurality of slots is formed along edges of the first panel.

5. The apparatus of claim 1, wherein the plurality of slots includes at least three slots.

6. The apparatus of claim 1, wherein the plurality of slots include at least one slot associated with at least one of sine, cosine, and tangent functions.

7. The apparatus of claim 1, wherein the surface of the first panel further includes a quadrant key to be utilized in determining a tangent value identified.

8. The apparatus of claim 1, wherein the first slotted link mechanism and the second slotted link mechanism are 90 degrees out of phase so when the first slotted link mechanism is centered along the first linear direction the second link mechanism is at a far end along the second linear direction.

9. The apparatus of claim 1, wherein
the first slotted link mechanism includes a first main body traversing in the second linear direction having a first slot formed therein and a first rod extending from a first end of the first body in the first linear direction and a second rod extending from a second end of the first body in the first linear direction, wherein the first and the second rods are used to enable movement of the first slotted link mechanism in the first linear direction, and wherein the second axle is secured within the first slot; and
the second slotted link mechanism includes a second main body traversing in the first linear direction having a second slot formed therein and a third rod extending from a first end of the second body in the second linear direction and a fourth rod extending from a second end of the second body in the second linear direction, wherein the third and the fourth rods are used to enable movement of the second slotted link mechanism in the second linear direction, and wherein the second axle is secured within the second slot.

10. The apparatus of claim 9, wherein
the first panel includes first channels formed along each side thereof, and
the second panel includes second channels formed along each side thereof in communication with the first channels so as to form first pathways for the first and the second rods to traverse back in forth in the first linear direction and second pathways for the third and the fourth rods to traverse back in forth in the second linear direction.

11. The apparatus of claim 10, wherein
the at least one first protrusion is located on the first main body so as to be internal to the first pathways; and
the at least one second protrusion is located on the second main body so as to be internal to the second pathways.

12. The apparatus of claim 1, wherein a connection means is formed between the first panel and the second panel to secure them together.

13. The apparatus of claim 12, wherein the connection means includes a tab formed in the second panel and a groove in the first panel, and the first panel and the second panel are secured by pushing the tab into the groove.

14-16. (canceled)
